(19) United States
(12) Patent Application Publication
(10) Pub. No.: US 2014/0126764 A1
(43) Pub. Date: May 8, 2014

(54) System and Method for Managing and Sharing Lottery Tickets via Mobile Devices

(71) Applicant: Yang Wang, Union City, CA (US)

(72) Inventor: Yang Wang, Union City, CA (US)

(21) Appl. No.: 13/667,519

(22) Filed: Nov. 2, 2012

(51) Int. Cl. G06K 9/18

(52) U.S. Cl. CPC G06K 9/18
USPC 382/100

(57) ABSTRACT

The embodiments herein disclose a system and a method for managing and sharing at-least one lottery ticket via a plurality of mobile devices. The system comprises a central server and a plurality of mobile devices. The plurality of mobile devices is connected to the central server via a communication media. The plurality of mobile devices comprises a data capturing unit, a data processing unit and a data sharing unit. The data capturing unit captures an image of a lottery ticket. The data processing unit converts a captured data into a plurality of data packets. The data processing unit compresses the plurality of data packets. The data sharing unit transfers the plurality of compressed data packets to the central server as well as a plurality of user devices. The central server implements a software application which reassembles the plurality of data packets received from the data sharing unit to form the lottery ticket.

### BACKGROUND

1. Technical Field of Invention

The embodiments herein generally relate to a system and a method for a data delivery and particularly relates to a system and a method for managing and sharing a plurality of data packets among a plurality of users through a communication medium. The embodiments herein more particularly relates to a system and a method for managing and sharing a lottery ticket among a plurality of users through a communication media.

2. Description of Related Art

A lottery is a form of gambling which involves a drawing of lots for a prize. A lottery comes in mans formats. For example, the prize is a fixed amount of cash or goods. In this format there is risk to the organizer if insufficient tickets are sold. A popular form of this is the “50-50” draw where the organizers promise that the prize will be 50% of the revenue. Many recent lotteries allow the purchasers to select the numbers on the lottery ticket, resulting in the possibility of multiple winners. In these recent lotteries, a printed piece of paper is provided with a fixed combination of numbers written over it. The final selection of the number from a lottery pool is done by a user or a purchaser. The finally selected numbers are attached or correlated with a lottery ticket which is registered in the favor of the user or the purchaser. The lottery management nowadays is done through an internet communication media.

One of the prior arts discloses a system and a method to manage a lottery pool over an internet media. The prior art facilitates a user to register in the central server and is provided a unique user identification number (user ID). The user is allowed to pay and purchase for a lottery ticket over a worldwide web server. The system in the prior art uses a random formulae to announce a winning number.

However the prior art uses an internet media to share a lottery ticket to a plurality of users which only allows to send a lottery combination number,

In the view of foregoing, there is need for a system and a method for managing and sharing a lottery ticket over at mobile network. Also, there is a need for a system and method for extracting a plurality of information about a lottery ticket.

The above mentioned shortcomings, disadvantages and problems are addressed herein, as detailed below.

### OBJECT OF THE INVENTION

The primary object of the embodiments herein is to provide a system and a method for managing and sharing a lottery ticket among a plurality of lottery players through a plurality of mobile devices.

Another object of the embodiments herein is to extract a plurality of information about a lottery ticket as well as the concerned user by analyzing an image of the lottery ticket.

Yet another object of the embodiments herein is to acquire a plurality of information through a mobile device.

These and other objects and advantages of the embodiments herein will become readily apparent from the following detailed description taken in conjunction with the accompanying drawings.

### SUMMARY OF THE INVENTION

The various embodiments herein disclose a system for managing and sharing at-least one lottery ticket via a plurality of mobile devices. The system comprises a central server and a plurality of mobile devices. The plurality of mobile devices is connected to the central server via a communication media. The plurality of mobile devices comprises a data capturing unit, a data processing unit and a data sharing unit. The data capturing unit captures an image of a lottery ticket and converts a captured data into a plurality of data packets. The data processing unit compresses the plurality of data packets. The data sharing unit transfers the plurality of compressed data packets to the central server as well as to a plurality of user devices. The plurality of user devices comprises a mobile device or a Personal Computer or a Laptop or a Personal Digital Application (PDA). The central server comprises an application repository. The application repository implements a software application which reassembles the plurality of data packets received from the data sharing unit to form the lottery ticket. The central server extracts a plurality of information about the lottery ticket. The software application comprises an Optical Character Recognition (OCR) to obtain the plurality of information. The OCR processes scanned images of a printed text into a machine-encoded text. The software application recognizes an image processed by the OCR. The software application compares the recognized image with a database provided in the application repository. The database consists of a plurality of lottery ticket images alongwith a plurality of related information.

According to one embodiment herein, the plurality of information comprises a drawing date, a purchasing date and a winning number.

According to one embodiment herein, the software application calculates a winning amount from the plurality of information.

According to one embodiment herein, the captured data comprises an image of the lottery ticket.

According to one embodiment herein, the communication media comprises a wired media or a wireless media.

The embodiments herein disclose a method for managing and sharing at-least one lottery ticket via a plurality of mobile devices. The method comprises capturing a data of a lottery ticket through a data capturing unit, convening the captured data into a plurality of data packets and compressing the plurality of data packets. The method further comprises transmitting the plurality of compressed data packets to a central server as well as a plurality of user devices. The plurality of user devices corpuses to mobile device or a Personal Computer or a Laptop or a Personal Digital Application (PDA). The method further comprises reassembling the plurality of data packets in the central server to form the lottery ticket and extracting a plurality of information about the reassembled lottery ticket through a software application implemented through the central server.

According to one embodiment herein, the software application comprises an Optical Character Recognition (OCR) to obtain the plurality of information. The OCR processes scanned images of a printed text into a machine-encoded text. The software application recognizes an image processed by OCR. The software application compares the recognized image with a database provided in the application repository. The database consists of a plurality of lottery ticket images alongwith a plurality of related information.

According to one embodiment herein the plurality of information comprises a drawing date, a purchasing date and a winning number.

According to one embodiment herein the captured data comprises an image of the lottery ticket.

According to one embodiment herein, the communication media comprises a wired media or a wireless media.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for managing and sharing a lottery ticket via a plurality of mobile devices, according to an embodiment herein.

FIG. 2 illustrates a flowchart of a method for managing and sharing a lottery ticket via a plurality of mobile devices, according to an embodiment herein.

### DETAILED DESCRIPTION OF THE DRAWINGS

In the following detailed description, a reference is made to the accompanying drawings that form a part hereof and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein disclose a system for managing and sharing at-least one lottery ticket via a plurality of mobile devices. The system comprises a central server and a plurality of mobile devices. The plurality of mobile devices is connected to the central server via a communication media. The plurality of mobile devices comprises a data capturing unit, a data processing unit and a data sharing unit. The data capturing unit captures an image of a lottery ticket and converts a captured data into a plurality of data packets. The data processing unit compresses the plurality of data packets. The data sharing unit transfers the plurality of compressed data packets to the central server as well as to a plurality of user devices. The plurality of user devices comprises a mobile device or a Personal Computer or a Laptop or a Personal Digital Application (PDA). The central server comprises an application repository. The application repository implements a software application which reassembles the plurality of data packets received from the data sharing unit to form the lottery ticket. The central server extracts a plurality of information about the lottery ticket. The software application comprises an Optical Character Recognition (OCR) to obtain the plurality of information. The OCR processes scanned images of a handwritten or a typewritten or a printed text into a machine-encoded text. The software application recognizes an image processed by the OCR. The software application compares the recognized image with a database provided in the application repository. The database consists of a plurality of lottery ticket images alongwith a plurality of related information.

According to one embodiment herein, the plurality of information comprises a drawing date, a purchasing date and a winning number.

According to one embodiment herein, the software application calculates a winning amount from the plurality of information.

According to one embodiment herein, the captured data comprises an image of the lottery ticket.

According to one embodiment herein, the communication media comprises a wired media or a wireless media.

The embodiments herein disclose a method for managing and sharing at-least one lottery ticket via a plurality of mobile devices. The method comprises capturing, a data of a lottery ticket through a data capturing unit, converting the captured data into a plurality of data packets and compressing the plurality of data packets. The method further comprises transmitting the plurality of compressed data packets to a central server as well as a plurality of user devices. The plurality of user devices comprises a mobile device or a Personal Computer or a Laptop or a Personal Digital Application (PDA). The method further comprises reassembling the plurality of data packets in the central server to form the lottery ticket and extracting a plurality of information about the reassembled lottery ticket through a software application implemented through the central server.

According to one embodiment herein, the software application comprises an Optical Character Recognition (OCR) to obtain the plurality of information. The OCR processes scanned images of a handwritten or a typewritten or a printed text into a machine-encoded text. The software application recognizes an image processed by OCR. The software application compares the recognized image with a database provided in the application repository. The database consists of a plurality of lottery ticket images alongwith a plurality of related information.

According to one embodiment herein the plurality of information comprises a drawing date, a purchasing date and a winning number.

According to one embodiment herein the captured data comprises an image of the lottery ticket.

According to one embodiment herein, the communication media comprises a wired. media or a wireless media.

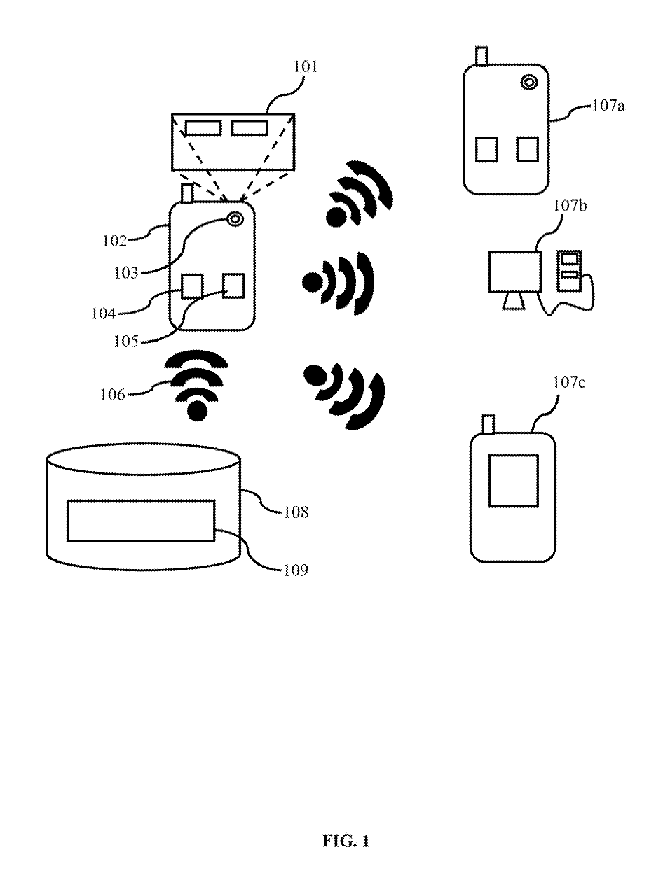

FIG. 1 illustrates a block diagram of a system for managing and sharing a lottery ticket via a plurality of mobile devices, according to an embodiment herein. With respect to FIG. 1, the system comprises a central server 108 and a plurality of mobile devices 102. The plurality of mobile devices 102 is connected to the central server 108 via a communication media 106. The plurality of mobile devices 102 comprises a data capturing unit 103, a data processing unit 104 and a data sharing unit 105. The data capturing unit 103 captures an image of a lottery ticket 101. The data processing unit 104 converts a captured data into a plurality of data packets. The data processing unit 104 compresses the plurality of data packets. The data sharing unit 105 transfers the plurality of compressed data packets to the central server 108. The data sharing unit 105 also transmits the compressed data packets to a plurality of user devices 107a-107c. The plurality of user devices 107a-107c comprises a mobile phone 107a or a Personal Computer 107b or a Laptop or a Personal Digital Application (PDA) 107e, The central server 108 implements a software application which reassembles the plurality of data packets received from the data sharing unit to form the lottery ticket 101. The central server 108 extracts a plurality of information about the lottery ticket 101. The software application resides in an application repository 109 in the central server 108. Further the software sends a notification about the winning combination of the numbers to a concerned user. The software application also intimates a plurality of user about a next lottery draw.

The software application comprises an Optical Character Recognition (OCR) to obtain the plurality of information.

The plurality of information comprises a drawing date, a purchasing date and a winning number. The software application calculates a winning amount from the plurality of information. The captured data comprises an image of the lottery ticket 101. The communication media 106 comprises a wired media or a wireless media.

According to one embodiment herein, the system also provides a secondary software application over a mobile device 102. The secondary application is downloadable from the central server 108 over the mobile device 102. The software application connects a mobile device 102 to the central server 108 after its initiation. The software application provides a plurality of secondary information to the user related to a purchased lottery ticket 101. The plurality of information comprises a preferred lottery ticket 101 with a preferred combination of the lottery numbers. The preferred combination of lottery numbers corresponds to a combination of numbers which has greater probability of winning. Further the software application provides an option of purchasing the lottery ticket 101 with preferred combination of numbers to the user.

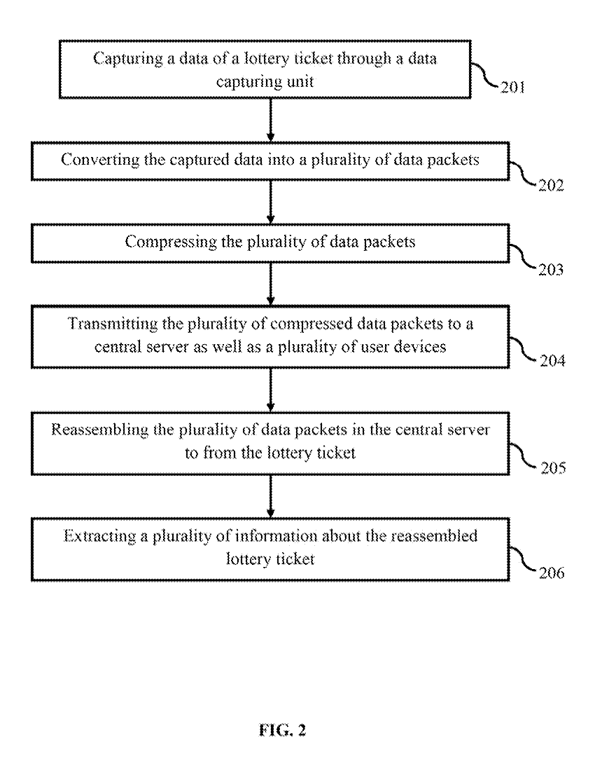

FIG. 2 illustrates a flowchart of a method for managing and sharing a lottery ticket via a plurality of mobile devices, according to an embodiment herein. With respect to FIG. 2, the method comprises capturing a data of a lottery ticket through a data capturing unit (201), converting the captured data into a plurality of data packets (202) and compressing the plurality of data packets (203). The method further comprises transmitting the plurality of compressed data packets to a central server as well as a plurality of user devices (204). The plurality of user devices comprises a mobile phone or a Personal Computer or a Laptop or a Personal Digital Application (PDA). The method further comprises reassembling the plurality of data packets in the central server to form the lottery ticket (205) and extracting a plurality of information about the reassembled lottery ticket through a software application implemented through the central server (206).

The software application comprises an Optical Character Recognition (OCR) to obtain the plurality of information. The plurality of information comprises a drawing date, a purchaser, a purchasing date and a winning number. The software application calculates a winning amount from the plurality of information. The captured data comprises an image of the lottery ticket The communication media comprises a wired media or a wireless media.

The software application alerts an amount of prize to a plurality of authorized users. A notification is sent via an electronic mail, a Push Notification Service or other methods.

The system and method herein facilitates sharing and managing the plurality of lottery tickets among the plurality of users in an easy manner. Further it is easy to take picture of lottery tickets with a mobile device embedding a digital camera, share and store the digital image to a central server via a communication media. Further, the software application on the central server provides a common stage to view, manage and share a plurality of information about the lottery tickets.

The present invention provides a system and a method to facilitates a plurality of users to take an image and generate information of the lottery tickets, store and share images of the lottery ticket, calculate prize, notify users with winning information and manage the credits for tickets purchasing.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims which will further be presented while presenting the completed specification or non-provisional application.

We claim:

1. A system for managing and sharing at-least one lottery ticket via a plurality of mobile devices, the system comprises:
a central server;
a plurality of mobile devices, wherein the plurality of mobile devices are connected to the central server via a communication media, wherein the plurality of mobile devices comprises:
a data capturing unit, and wherein the data capturing unit captures an image of a lottery ticket;
a data processing unit, wherein the data processing unit converts a captured data into a plurality of data packets, and wherein the data processing unit compresses the plurality of data packets; and
a data sharing unit, wherein the data sharing unit transfers the plurality of compressed data packets to the central server, wherein the data sharing unit also transmits the compressed data packets to a plurality of user devices, and wherein the plurality of user devices comprises a mobile phone or a Personal Computer or a Laptop or a Personal Digital Application (PDA); and
wherein the central server comprises an application repository, wherein the application repository implements a software application which reassembles the plurality of data packets received from the data sharing unit to form the lottery ticket, wherein the central server extracts a plurality of information about the lottery ticket, and wherein the software application comprises an Optical Character Recognition (OCR) to obtain the plurality of information, wherein the OCR processes scanned images of a handwritten or a typewritten or a printed text into a machine-encoded text, wherein the software application recognizes an image processed by OCR, wherein the software application compares the recognized image with a database provided in the application repository, and wherein the database consists of a plurality of lottery ticket images alongwith a plurality of related information.

2. The system according to claim 1, wherein the plurality of information comprise a drawing date, a purchasing date and a winning number.

3. The system according to claim 1, wherein the software application calculates a winning amount from the plurality of information.

4. The system according to claim 1, wherein the captured data comprises an image of the lottery ticket.

5. The system according to claim 1, wherein the communication media comprises a wired media or a wireless media.

6. A method for managing and sharing at-least one lottery ticket via a plurality of mobile devices, the method comprises:
capturing a data of a lottery ticket through a data capturing unit;
convening the captured data into a plurality of data packets;
compressing the plurality of data packets;
transmitting, the plurality of compressed data packets to a central server as well as a plurality of user devices, wherein the plurality of user devices comprises a mobile phone or a Personal Computer or a Laptop or a Personal Digital Application (PDA);
reassembling the plurality of data packets in the central server to form the lottery ticket; and
extracting a plurality of information about the reassembled lottery ticket through a software application implemented through the central server.

7. The method according to chum 6, wherein the software application comprises an Optical Character Recognition (OCR) to obtain the plurality of information, wherein the OCR processes scanned images of a handwritten or a typewritten or a printed text into a machine-encoded text, wherein the software application recognizes an image processed by OCR., wherein the software application compares the recognized image with a database provided in the application repository, and wherein the database consists of a plurality of lottery ticket images alongwith a plurality of related information.

8. The method according to claim 6, wherein the plurality of information comprise a drawing date, a purchasing date and a winning number.

9. The method according to claim 6, wherein the captured data comprises an image of the lottery ticket.

10. The method according to claim 6, wherein the communication media comprises a wired media or a wireless media.
